(19) United States
(12) Patent Application Publication
(10) Pub. No.: US 2024/0265157 A1
(43) Pub. Date: Aug. 8, 2024

(54) DESIGN OF ACTIVE RESILIENT STRUCTURES

(71) Applicant: Palo Alto Research Center Incorporated, Palo Alto, CA (US)

(72) Inventors: Raman GOYAL, Mountain View, CA (US); Anurag BHATTACHARYYA, Mountain View, CA (US); Amirmassoud MIRZENDEHDEL, Millbrae, CA (US); Morad BEHANDISH, San Mateo, CA (US)

(21) Appl. No.: 18/162,130

(22) Filed: Jan. 31, 2023

(51) Int. Cl. G06F 30/13; G06F 30/20

(52) U.S. Cl. CPC G06F 30/13; G06F 30/20; G06F 2119/02

(57) ABSTRACT

A systematic framework to design active resilient structures that simultaneously optimizes the characteristics of the system to yield an optimal solution in terms of robustness to external disturbance, uncertainty in structural properties, and structural faults. The proposed approach will yield a preferred or optimal solution as opposed to designing individual components of the complete system. The framework provides the preferred or optimal location and precision of heterogeneous sensors and stimuli-sensitive active actuators and the control law guiding these active actuators to control the resilient structure. The framework provides a systematic approach to designing active resilient structures by choosing the location of smart actuators/sensors to mitigate the unwanted effects of uncertain structural properties. The framework is the first systematic integration of thermally activated shape memory polymer actuators and their guiding law with a sensor distribution framework targeted to bring a damaged/disturbed structural system to its native state.

### FEDERALLY SPONSORED RESEARCH AND DEVELOPMENT

N/A

### JOINT RESEARCH AGREEMENT

N/A

### BACKGROUND OF THE INVENTION

The present application generally relates to designing structures and, more specifically, using actuators that change their shape in response to stimuli, such as actuators based on shape-memory polymers and shape-memory alloys incorporated into the design.

Active resilient structure design and its controller selection are not two independent problems. Rather, the design and controller selection should be integrated such that the dynamics of the controller and the structure cooperate to meet performance objectives. Currently, the industry focus is on the design of individual components. These individual components are modified at the last step to bring all the individual components together. This results in a suboptimal solution. A need exists to produce system designs where all system components are cooperatively designed to yield a specified system performance.

### SUMMARY OF THE INVENTION

Disclosed is a systematic framework to design active resilient structures that simultaneously optimizes the characteristics of the system to yield a preferred or optimal solution in terms of robustness to external disturbance, uncertainty in structural properties, and structural faults. The proposed approach yields a preferred or optimal solution as opposed to designing individual components of the complete system. The framework provides the preferred or optimal location and precision of heterogeneous sensors and stimuli-sensitive active actuators and the control law guiding these active actuators to control the resilient structure.

The present invention combines the controller design and the design of the active resilient structure. The controller design includes the control algorithm that accesses sensors measurements as input and outputs signal for the actuators. The design of active resilient structure includes finding the location and precision of sensors and stimuli-sensitive active actuators. This integration of the active resilient structure design and the controller design helps to guarantee the desired performance of the active resilient structure.

More specifically, disclosed is a system and computer-implemented method for placing one of sensors, stimuli sensitive actuators, or both and generating control parameters in an active resilient structure design. The method begins with receiving an initial design domain for a truss structure formed from a plurality of members connected by nodes, the initial design domain including one of i) the feasible location of sensors, ii) the feasible location of stimuli sensitive actuators, or iii) both. The initial design domain, in one example, also includes the number of stimuli sensitive actuators or sensors or both. Examples of stimuli sensitive actuators are one of i) shape-memory polymers (SMP) actuators, ii) shape-memory alloy (SMA), or both.

In one example, the design criteria for the active resilient structure includes receiving the design criteria with one of i) loading conditions, ii) boundary conditions, iii) initial conditions, or iv) a combination thereof.

In another example, the design criteria for the active resilient structure includes receiving the design criteria with one of i) a node displacement performance bound, ii) a node position performance bound, iii) a node velocity performance bound, or iv) a combination thereof.

In still another example, the design criteria for the active resilient structure, includes receiving one of i) a minimum bound for covariance of a node, ii) a maximum bound for the covariance of the node, or ii) both, to transform one or more characteristics of the active resilient structure towards a passive resilient structure.

In yet, still another example, the design criteria for the active resilient structure, includes a force output of one or more stimuli sensitive actuators, and wherein producing the design workflow to generate one or more designs of the part includes using the force output to produce the design workflow to provide self-reconfiguring of the active resilient structure.

Next the method continues to iteratively solving a joint optimization problem of a control algorithm and one of i) the feasible locations of sensors, ii) the feasible locations of stimuli sensitive actuators, or iii) both, by repeatedly solving for i) the feasible location of sensors, ii) topology, iii) geometry, or iv) a combination thereof, until reaching one of i) a predefined number of stimuli sensitive actuators, ii) a predefined number of sensors, iii) a predefined cost of the truss structure, iv) a predefined computational performance or v) a combination thereof.

In one example, iteratively solving the joint optimization problem results in simultaneous solutions for the control algorithm and the location of sensors to gather maximum information of the active resilient structure and the control algorithm to neutralize a change due to one of i) uncertainty in the properties of the active resilient structure, ii) faults in the active resilient structure, or iii) both.

In one example, iteratively solving the joint optimization problem results in simultaneous solutions for the control algorithm and the location of stimuli sensitive actuators to actively control the active resilient structure and the control algorithm to neutralize a change due to one of i) uncertainty in the properties of the active resilient structure, ii) faults in the active resilient structure, or iii) both.

In another example, iteratively solving the joint optimization problem results in simultaneous solutions for the control algorithm and the location of sensors to gather maximum information of the active resilient structure and the control algorithm to neutralize a change due to one of i) uncertainty in environmental conditions of the active resilient structure, ii) external disturbances to the active resilient structure, or iii) both.

In still another example, iteratively solving the joint optimization problem results in simultaneous solutions for the control algorithm and the location of stimuli sensitive actuators to actively control the active resilient structure and the control algorithm to neutralize a change due to one of i) uncertainty in environmental conditions of the active resilient structure, ii) external disturbances to the active resilient structure, or iii) both.

A design workflow is produced to generate one or more designs of a part to comply with a solution to the joint optimization problem that produces the active resilient structure with the location of sensors, location of stimuli sensitive actuators and parameters for the control algorithm.

In one example, the design workflow includes the use of additive manufacturing to form one or more of the stimuli sensitive actuators.

### BRIEF DESCRIPTION OF DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example of an actuator that changes its shape in response to thermal stimuli as used in an active resilient truss structure;

FIG. 2 is a block diagram of an active control of a resilient structure with preferred or optimal sensor/actuator placement;

FIG. 3 is an illustration of a truss structure illustrating a point of interest;

FIG. 4 and FIG. 4A through FIG. 41 is an illustration of SMP-based actuator placement, sensor placement for node position measurement, and results of different simulations to neutralize the effect of structural uncertainty, environment disturbance, and initial uncertainty by bounding the location of the node of interest;

FIG. 5 and FIG. 5A through FIG. 51 is another illustration of SMP-based actuator placement, sensor placement for coordinate measurement of nodes, and simulation results like FIG. 4 but with a higher complexity truss structure.

FIG. 6 is a flow diagram for designing resilient structures; and

FIG. 7 illustrates an example computer architecture that can implement methods of FIGS. 2-6 described herein.

### DETAILED DESCRIPTION OF THE INVENTION

As required, detailed embodiments are disclosed herein; however, it is to be understood that the disclosed embodiments are merely examples and that the systems and methods described below are embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather, to provide an understandable description.

The presently claimed invention provides a systematic approach to designing active resilient structures by choosing the location of smart actuators/sensors to mitigate the unwanted effects of uncertain structural properties. The proposed framework is the first systematic integration of thermally activated shape memory polymer actuators and their guiding law with a sensor distribution framework targeted to bring a damaged/disturbed structural system to its native state. The approach enables the design of resilient smart structures that can be additively manufactured. The framework computes values of relative importance (precision) for different sensor positions and actuator positions and uses the precision metric to optimally place active material to reconfigure the system in presence of uncertainty and faults.

### Non-Limiting Definitions

The terms “a”, “an” and “the” are intended to include the plural forms as well, unless the context clearly indicates otherwise.

The term “actuator” is a component of a machine that is responsible for moving and controlling a mechanism or system. Types of actuators include hydraulic, pneumatic, electric, thermal, mechanical, and soft actuators, also known as stimuli sensitive actuator, which change their shape in response to stimuli, including mechanical, thermal, magnetic, and electrical.

The term “additive manufacturing” is the construction of a three-dimensional object from a CAD model or a digital 3D model. It can be done in a variety of processes, including 3D printing, in which material is deposited, joined, or solidified under computer control, with the material being added together (such as plastics, liquids, or powder grains being fused), typically layer by layer.

The phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “boundary condition” means is a location on a structure where either the external force or the displacement are known at the start of the analysis.

The term “connected” or “coupled” means an element is connected to another element, it can be directly connected or coupled to the other element or intervening elements may be present. In contrast, when an element is referred to as being “directly connected” or “directly coupled” to another element, there are no intervening elements present.

The term “design domain” reference to topology, size, shape, loading, boundary condition, and other criteria needed for a design of a structure.

The term “design workflow” is a process of generating one or more designs of a part to comply with one or more of satisfying constraints while solving an optimization problem.

The term “feasible location” is used to mean a placement of a sensor or smart actuator at a workable or a practical location on a truss structure but it does not necessary mean at all possible locations on the truss structure.

The phrase “geometry of a truss structure” is the shape of members or bars that form triangled and other rigid shapes. Most trusses are based on the geometric rigidity of the triangle shape.

The term “optimization” or “preferred” is used to mean a better solution given the constraints, not necessarily the best or near best solution.

The term “passive resilient structure” means an active resilient structure whose control capability is reduced to zero or near zero, or does not have control/actuation capability from the start.

The term “predefined computational performance” means an amount of useful work computer system. Outside of specific contexts, computer performance is estimated in terms of accuracy, efficiency and speed of executing computer program instructions.

The term “sensor” is a device that produces an output signal for the purpose of sensing a physical phenomenon. The sensor may include acoustic, chemical, ionization, electric, sound, vibration, pressure, force, flow, shape, thermal, and proximity. For example, a Bragg grating sensor network to monitor the morphing wing profile (shape sensing) and measure the strain actuation.

The term “shape-memory alloy” (SMA) is an alloy that can be deformed when cold but returns to its pre-deformed, i.e., “remembered” shape when heated.

The term “shape-memory polymers” (SMPs) are polymeric smart materials that have the ability to return from a deformed state (temporary shape) to their original (permanent) shape when induced by an external stimulus (trigger), such as temperature change.

The phrase “topology of a truss structure” is the connectivity of the various shapes, members and sizing of a truss.

The term “truss” is an assembly of members, connected by nodes, that creates a structure.

### Stimuli-Sensitive Actuators

A stimuli sensitive actuator is one that changes its shape in response to stimuli, including mechanical, thermal, magnetic, and electrical. As an example of a stimuli-sensitive actuator is “shape-memory polymers” (SMPs) that have the ability to return from a deformed state (temporary shape) to their original (permanent) shape when induced by an external stimulus (trigger), such as temperature change.

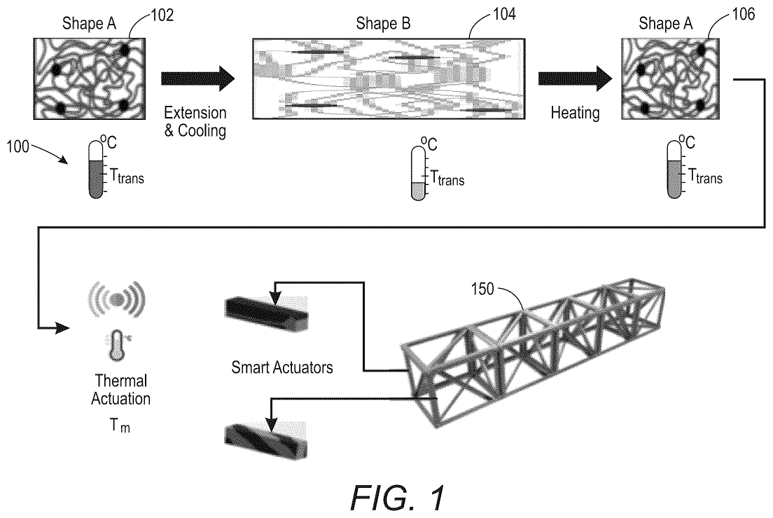

Turning now to FIG. 1, shown is an example of an actuator 102, 104, 106, that changes its shape in response to thermal stimuli as used in an active resilient truss structure 150 as shown.

Polymers exhibiting a shape-memory effect have both a current/temporary form and a stored/permanent form. These SMP contain at least two separate phases 1) one used for a permanent shape Tₚₑᵣₘ during manufacturing and 2) used for switching segments. The switching segments are shown in FIG. 1. The segments in Shape_A 102 with the ability to soften past a certain transition temperature (Tₜᵣₐₙₛ) and are responsible for the temporary shape (Shape B) 104. Exceeding Tₜᵣₐₙₛ (while remaining below Tₚₑᵣₘ) activates the switching by softening these switching segments and thereby allowing the material to resume its original (permanent) form 106 (Shape_A). Below Tₜᵣₐₙₛ, the flexibility of the segments is at least partly limited. If Tₘ is chosen for programming the SMP, strain-induced crystallization of the switching segment can be initiated when it is stretched above Tₘ and subsequently cooled below Tₘ.

### Overview

Disclosed is a computational framework to design active resilient structures considering overall system design architecture, i.e., simultaneous optimization of sensor/actuator placement and active control design. The structures will be designed to achieve high performance where performance can be referred to as—disturbance rejection or neutralize the effects of structural faults or minimum control efforts (with a limit to passive structure) to achieve the desired level of resiliency and reconfigurability. The framework automatically and optimally places a fixed number of sensors and stimuli-sensing smart actuators such that the system can reconfigure itself to neutralize the effects of uncertainty in structural properties, environmental disturbance, and structural faults.

Sensor/actuator placement and active control design: The preferred or optimized placement of heterogeneous sensors and smart actuators will increase the structure's diagnosability and reconfigurability, considering both collocated and distributed sensors/actuators with budget constraints. The stimuli-reactive force acting on the structure is obtained using the actuator constitutive behavior to find the actuators' preferred or optimized location to neutralize the faults' effects. A control algorithm co-designed with the structural properties and location of sensors/actuators will allow us to achieve a more optimal solution.

Approach for the solution: A linear matrix inequalities-based novel computational design co-optimization framework that will simultaneously optimize the location of sensors and smart actuator characteristics and control law with a system-control framework to neutralize the effects of structural faults, to reject external disturbance and to compensate for the unmodeled dynamics through a mathematically rigorous formulation.

The location of sensors and actuators is optimized by distributing them throughout the structure and finding the optimum precision (inverse of noise-to-signal ratio) to achieve desired performance. The obtained sensor/actuator precision provides the importance of that location, e.g., remove the sensor with zero precision. This problem can be solved by iteratively solving the joint optimization problem and keep removing the actuator/sensor with the least precision to obtain the structure with the required number of smart actuators and heterogeneous distribution of sensors.

### Problem Formation

### System Description

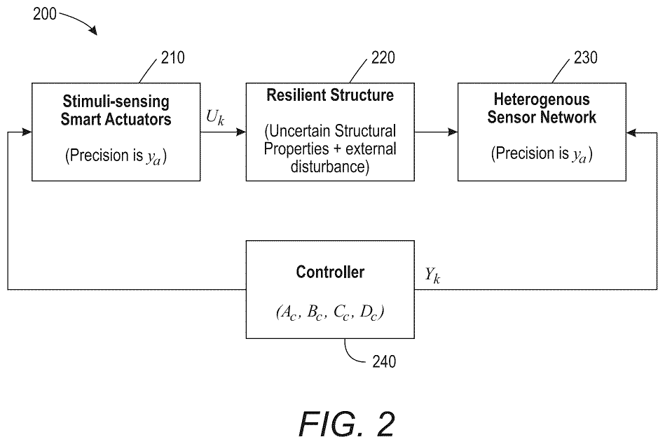

Turning now to FIG. 2, shown is a block diagram 200 of an active control of a resilient structure with optimal sensor/actuator placement. More specifically, shown is a systematic framework to design active resilient structures that simultaneously optimizes the characteristics of the system to yield an optimal solution in terms of robustness to external disturbance, uncertainty in structural properties, and structural faults. The framework produces a preferred or optimal solution for co-designing the location and precision of heterogeneous sensors and stimuli-sensitive active actuators and the control law guiding these active actuators as opposed to designing individual components of the complete system.

The major components of FIG. 2 include stimuli sensitive actuators 210 disposed on a resilient structure 220, such as a truss of FIG. 1. The structure includes an initial design domain formed from a plurality of members connected by nodes. The initial design domain may include other properties and external disturbances. The block diagram includes a heterogeneous sensor network 230 and a controller 240 with variables Ac, Bc, Cc, Dc, as shown. The values yₖ, uₖ and Ys are described in equations 1 through 31 as follows.

Consider a discrete-time linear time-invariant (LTI) system described by the following state-space representation:

$${x}_{k + 1} = {Ax}_{k} + {Bu}_{k} + {Dw}_{k}^{p} + {Ew}_{k}^{a} , \qquad ( 1 )$$

$${y}_{k} = {Cx}_{k} + {v}_{k} , \qquad ( 2 )$$

where xₖ∈Rⁿ^{ₓ} is the state of the system at time k, uₖ∈Rⁿ^{ᵤ} is the control vector at time k. The initial state vector x₀ and the process noise at time k, wₖ^{p}, are assumed to be independent random variables. In particular, wₖ^{p}˜ [symbol] (0, W^{p}), ∀k, with W^{p}∈Rⁿ^{_{w}}^{×n}^{_{w}} to be known and fixed covariance matrix. The output of the system yₖ∈Rⁿ^{_{y}}, is measured by a sensor network with noise modeled as IID Gaussian random variable with zero mean and covariance—vₖ˜ [symbol] (0, V), ∀k with V∈Rⁿ^{ᵥ}^{×n}^{ᵥ} to be the covariance matrix. Similarly, the actuator noise is also modeled as IID Gaussian random variable with zero mean and covariance—wₖ^{a}˜ [symbol] (0, W^{a}), ∀k with W^{a}∈Rⁿ^{ᵤ}^{×n}^{ᵤ} to be the covariance matrix.

The uncertainty in the structural properties can arise from uncertainty in the material properties, uncertainty in the geometry/dimensions of the elements, and imperfect manufacturing methods. These uncertainties can be modeled using uncertain system matrices ΔA, ΔB, ΔC, ΔD and ΔE. A conservative approach in a robust control framework is to design control law for the worst-case scenario, i.e., considering the system with poles on the far right-hand side or far out the unit circle in case of discrete system representation.

Assume noisy actuators and measurement sensors, but the intensity of those noises are optimization variables (specifically, the inverse of noise is defined to be the precision and solve for the precision). The cost of actuators and sensors is assumed to be directly proportional to their precision to add a budget constraint to the problem. Let us define the inverse of covariance of the actuator noise and sensor noise signal as:

$${Γ}_{a} {=}^{Δ} {W}^{{a}^{- 1}} , {Γ}_{s} {=}^{Δ} {V}^{- 1} , \qquad ( 3 )$$

and now, one of the goals is to find the optimization variables Γₐ and Γₛ denoting the strength of the actuator noise and sensor noise signal, which can also specify the channels which should be actuated and measured. The vector γₐ and γₛ are defined such that:

$${Γ}_{a} {=}^{Δ} diag ( {γ}_{a} ) , {Γ}_{s} {=}^{Δ} diag ( {γ}_{s} ) . \qquad ( 4 )$$

As defined in the incorporated reference [1] listed at the end, a price is associated with each actuator and sensor that is inversely proportional to the noise intensity associated with that instrument, and thus, the instrument price can be expressed as:

$$\$ = {p}_{a}^{T} {γ}_{a} + {p}_{s}^{T} {γ}_{s} , \qquad ( 3 )$$

where pₐ and pₛ are vectors representing the price per unit of actuator and sensor precision. The problem formulation is general and can be used for different structures with different boundary and loading conditions.

### Controller Design and Optimal Active Material Placement for Reconfiguration

### Full State Feedback Controller

Design a state feedback controller u=Kx and simultaneously select the actuator precisions for the following system:

$${x}_{k + 1} = A {x}_{k} + B {u}_{k} + D {w}_{k}^{p} + E {w}_{k}^{a} , \qquad ( 6 )$$

$${y}_{k} = C {x}_{k} . \qquad ( 7 )$$

It is a standard result that the above closed-loop system is stable and a steady-state state covariance matrix (X>0) exists, if:

$$( A + BK ) {X ( A + BK )}^{T} + [ D E ] {W [ D E ]}^{T} < X , \qquad ( 8 )$$

where W is the covariance matrix and the notation “0” (“I”) is used for zero (unit) matrix of appropriate dimensions:

$$W = [ \begin{matrix}{W}^{p} & O \\ O & {W}^{a}\end{matrix} ] . \qquad ( 9 )$$

The inequality again can be written as:

$$X - ( A + BK ) {XX}^{- 1} {{X}^{T} ( A + BK )}^{T} - [ D E ] {W [ D E ]}^{T} > O . \qquad ( 10 )$$

Applying Schur's complement on (22) gives:

$$[ \begin{matrix}X & ( A + BK ) X & D & E \\ {( \cdot )}^{T} & X & O & O \\ {( \cdot )}^{T} & {( \cdot )}^{T} & {W}^{{p}^{- 1}} & O \\ {( \cdot )}^{T} & {( \cdot )}^{T} & O & {W}^{{a}^{- 1}}\end{matrix} ] > O , \qquad ( 11 )$$

where (·)^{T} represents the corresponding transpose of the symmetric block. By defining a new variable Y=KX, the above equation can be written as:

$$[ \begin{matrix}X & AX + BY & D & E \\ {( \cdot )}^{T} & X & O & O \\ {( \cdot )}^{T} & {( \cdot )}^{T} & {W}^{{p}^{- 1}} & O \\ {( \cdot )}^{T} & {( \cdot )}^{T} & O & {W}^{{a}^{- 1}}\end{matrix} ] > O , \qquad ( 12 )$$

It is straightforward to show that the output covariance can be bounded as:

$${CXC}^{T} < \overline{Y} , \qquad ( 13 )$$

which can be written as:

$$[ \begin{matrix}\overline{Y} & CX \\ {( \cdot )}^{T} & X\end{matrix} ] > O . \qquad ( 14 )$$

Now the final problem is to solve for optimization variables X, Y, and Γₐ to satisfy the requirements on $ and Y̅. Finally, the feedback gain K can be calculated as: K=YX⁻¹.

### Dynamic Controller

Let us write the dynamic controller of the following form:

$${x}_{k + 1}^{c} = {A}_{c} {x}_{k}^{c} + {B}_{c} {y}_{k} , \qquad ( 15 )$$

$${u}_{k} {=}^{Δ} {C}_{c} {x}_{k}^{c} + {D}_{c} {y}_{k} . \qquad ( 16 )$$

A standard result in the literature requires the direct feedforward term in the dynamic controller to be zero for the bounded control input covariance. Thus, assume D_{c}=0 for the rest of the analysis. Using the above compensator, the closed-loop system dynamics can be written using the augmented state vector x^{T}:=[x^{T} x^{c}^{^{T}}] with augmented process noise w^{T}:=[W^{a}^{^{T}} W^{p}^{^{T}} v^{T}] as:

$${x}_{k + 1} = 𝔸 {x}_{k} + 𝔹 {w}_{k} , \qquad ( 17 )$$

$${y}_{k} = ℂ {x}_{k} + 𝔻 {w}_{k} , \qquad ( 18 )$$

where

$$𝔸 = [ \begin{matrix}A & {BC}_{c} \\ {B}_{c} C & {A}_{c}\end{matrix} ] , \qquad ( 19 )$$

$$𝔹 = [ \begin{matrix}E & D & 0 \\ 0 & 0 & {B}_{c}\end{matrix} ] ,$$

$$ℂ = [ \begin{matrix}C & 0\end{matrix} ] , \qquad ( 20 )$$

$$𝔻 = [ \begin{matrix}0 & 0 & I\end{matrix} ] ,$$

and wₖ˜ [symbol] (0, [symbol] ), where [symbol] :=Diag{W^{a}, W^{p}, V}. It is a standard result that the above closed-loop system is stable and a steady-state state covariance matrix ( [symbol] >0) exists, if:

$${𝔸𝕏𝔸}^{T} + {𝔹𝕎𝔹}^{T} < 𝕏 , \qquad ( 21 )$$

which again can be written as:

$$𝕏 - {𝔸𝕏𝕏}^{- 1} {𝕏}^{T} {𝔸}^{T} - {𝔹𝕎𝔹}^{T} > 0. \qquad ( 22 )$$

Applying Schur's complement on (23) gives:

$$[ \begin{matrix}𝕏 & 𝔸𝕏 & 𝔹 \\ {\text{(·)}}^{T} & 𝕏 & 0 \\ {\text{(·)}}^{T} & {\text{(·)}}^{T} & {𝕎}^{- 1}\end{matrix} ] > 0 , \qquad ( 23 )$$

where (·)^{T} represents the corresponding transpose of the symmetric block and [symbol] is the covariance matrix corresponding to [symbol] , the inverse of which is:

$${𝕎}^{- 1} = [ \begin{matrix}{Γ}_{a} & 0 & 0 \\ 0 & {W}^{{p}^{- 1}} & 0 \\ 0 & 0 & {Γ}_{s}\end{matrix} ] . \qquad ( 24 )$$

It is straightforward to show that the output covariance can be bounded as:

$${ℂ𝕏ℂ}^{T} + {𝔻𝕎𝔻}^{T} < \overline{Y} , \qquad ( 25 )$$

which can be written as:

$$[ \begin{matrix}\overline{Y} & ℂ𝕏 & 𝔻 \\ {\text{(·)}}^{T} & 𝕏 & 0 \\ {\text{(·)}}^{T} & {\text{(·)}}^{T} & {𝕎}^{- 1}\end{matrix} ] > 0. \qquad ( 26 )$$

Notice that the constraint in Eqn. (23) is not an LMI. A congruence transformation is performed, and a change of variables to convert them to LMIs see incorporated references [1,2] at the end. Let us define and partition the matrix as:

$$𝕏 {=}^{Δ} [ \begin{matrix}X & {P}^{T} \\ P & \hat{X}\end{matrix} ] ,$$

$${𝕏}^{- 1} {=}^{Δ} [ \begin{matrix}Y & S \\ {S}^{T} & \hat{Y}\end{matrix} ] ,$$

and the transformation matrix

[symbol]

$$𝕋 {=}^{Δ} [ \begin{matrix}I & Y \\ 0 & {S}^{T}\end{matrix} ]$$

and associated congruence transformation { [symbol] }

$$𝒯 {=}^{Δ} [ \begin{matrix}𝕋 & 0 & 0 \\ 0 & 𝕋 & 0 \\ 0 & 0 & I\end{matrix} ] ,$$

$$\tilde{𝒯} {=}^{Δ} [ \begin{matrix}I & 0 & 0 \\ 0 & 𝕋 & 0 \\ 0 & 0 & I\end{matrix} ] ,$$

respectively. Then applying { [symbol] } to Eqn. (23) and Eqn. (27), results in:

$${𝒯}^{T} [ \begin{matrix}𝕏 & 𝔸𝕏 & 𝔹 \\ {\text{(·)}}^{T} & 𝕏 & 0 \\ {\text{(·)}}^{T} & {\text{(·)}}^{T} & {𝕎}^{- 1}\end{matrix} ] 𝒯 > 0 , \qquad ( 27 )$$

$${\tilde{𝒯}}^{T} [ \begin{matrix}\overline{Y} & ℂ𝕏 & 𝔻 \\ {\text{(·)}}^{T} & 𝕏 & 0 \\ {\text{(·)}}^{T} & {\text{(·)}}^{T} & {𝕎}^{- 1}\end{matrix} ] \tilde{𝒯} > 0. \qquad ( 28 )$$

Expansion of (27) and (28) under an appropriate change of variables leads to a set of LMIs that does not depend on S or P. Once the X, Y are obtained, matrices S and P need to be constructed using:

$$YX + SP = I . \qquad ( 29 )$$

Notice that when the controller has the same order as the plant, S and P are square and non-singular matrices, in which case the controller gain matrices can be calculated as:

$$[ \begin{matrix}{A}_{c} & {B}_{c} \\ {C}_{c} & {D}_{c}\end{matrix} ] = [ \begin{matrix}{S}^{- 1} & - {S}^{- 1} YB \\ 0 & I\end{matrix} ] \cdot [ \begin{matrix}Q - YAX & F \\ L & 0\end{matrix} ] \cdot [ \begin{matrix}{P}^{- 1} & 0 \\ - {CXP}^{- 1} & I\end{matrix} ] . \qquad ( 30 )$$

Another constraint to consider for a feasible controller is to have a finite bound on the control input covariance:

$${𝔼}_{∞} ( {u}_{k} {u}_{k}^{T} ) < \overline{U} . \qquad ( 31 )$$

which uses the earlier-mentioned condition: D_{c}=0.

### Active Resilient Design Example

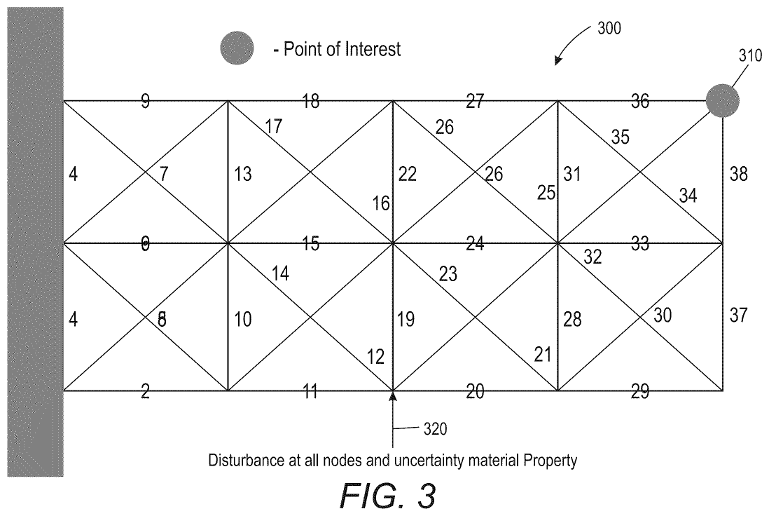

An example of truss based structure is used to illustrate the proposed concept of designing active resilient structures by automatically placing actuators and sensors and designing control law. The actuators are placed along truss members and the sensors at nodes. The truss structure 300 is shown in FIG. 3 and is modeled as a spring-mass-damper system. The objective is to neutralize the effect of structural uncertainty by bounding the position of the node of interest 310, and the control input is the vector of temperature that would actuate the shape memory polymer (SMP) based smart actuator. The disturbance 320 at different nodes comes in the form of force, and there is a probability distribution corresponding to the properties of the truss elements.

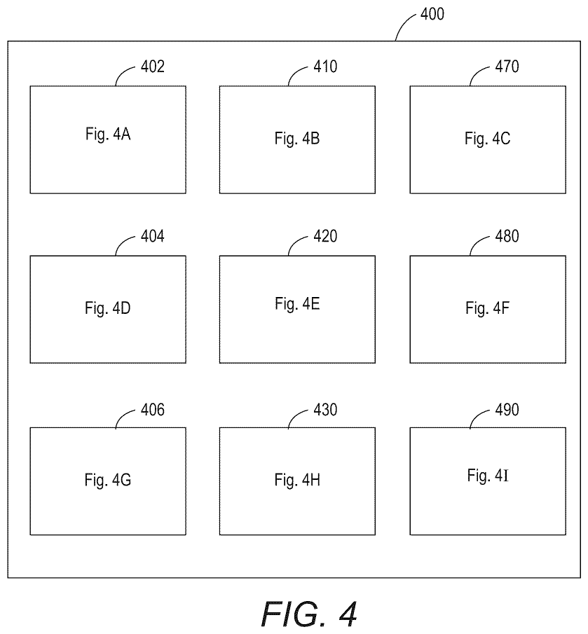

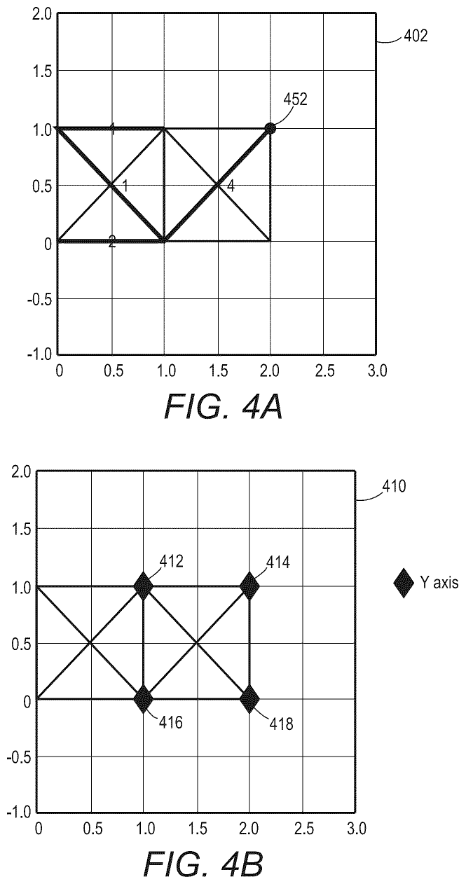

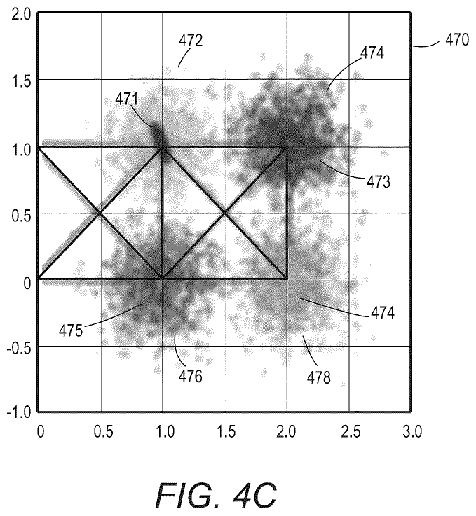

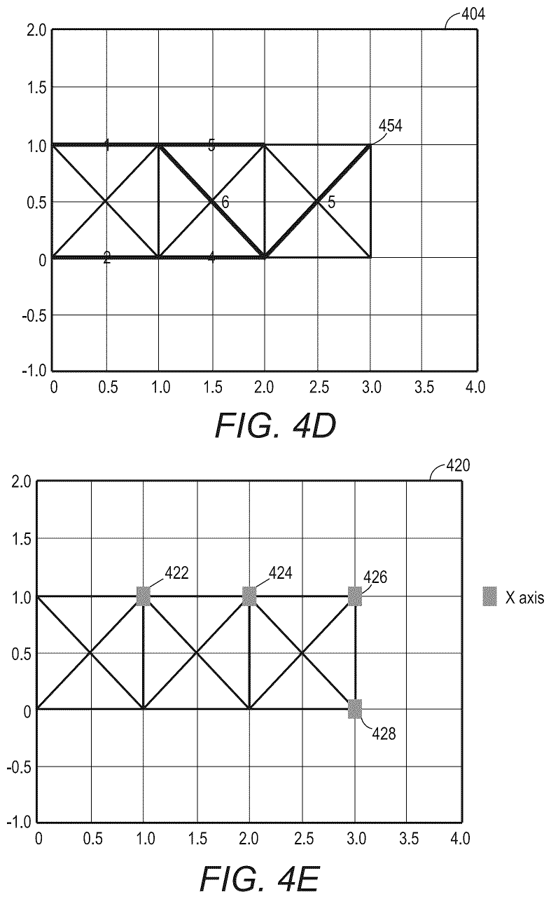

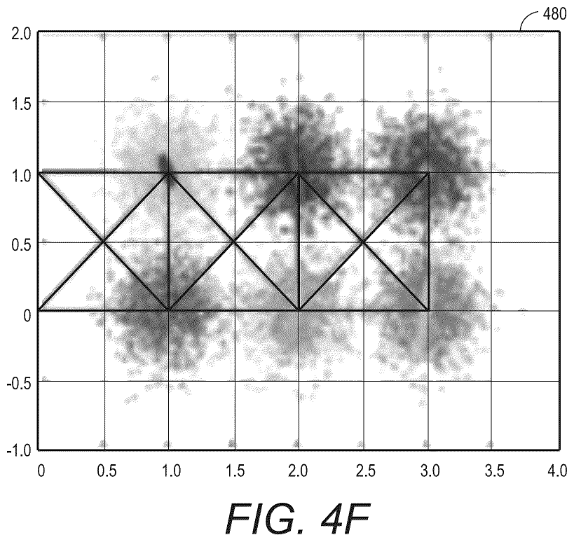

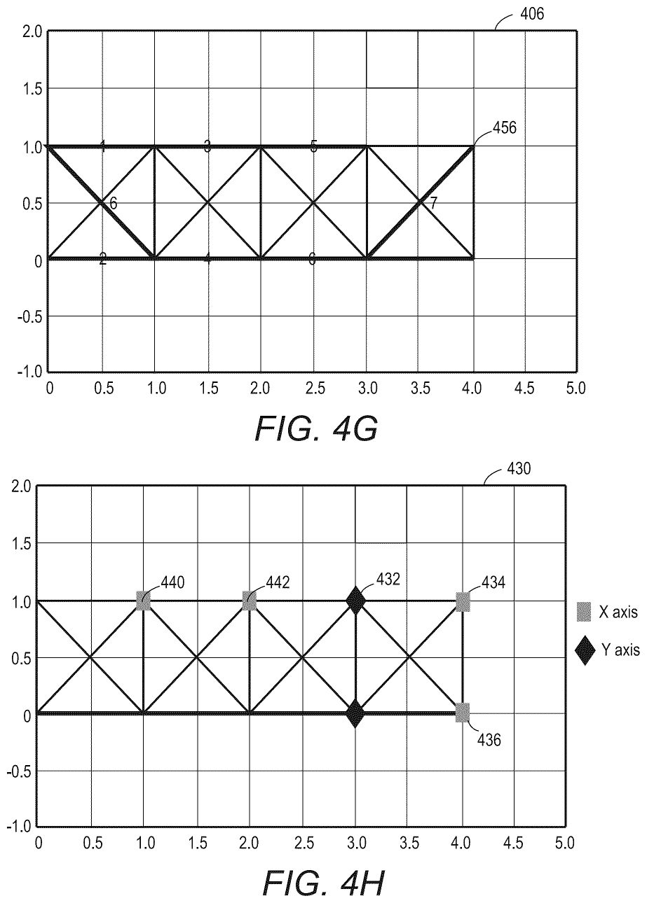

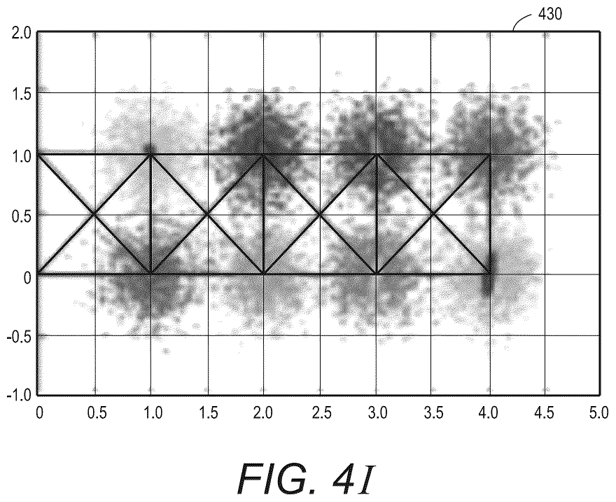

Turning to FIG. 4 and FIG. 4A through FIG. 41, shown is a series of graphs 400 of SMP-based actuator placement, sensor placement for coordinate measurement of nodes, and simulation results for 1000 different simulations to neutralize the effect of structural uncertainty, environment disturbance, and initial uncertainty by bounding the location of the node of interest.

The lines depected with in bold in the first column 402, 404, 406 of FIG. 4 show SMP-based optimal actuator placement for different complexity of truss models to neutralize structural uncertainty, environment disturbance, and initial uncertainty. The number on the bold lines represents the ranking of the importance of the active material for that particular structure.

The second column 410, 420, 430 shows the relative importance of measuring different nodes' positions in the x and y directions, with a diamond shape (e.g., +) 412, 414, 416, 432, 434 representing the y-axis and a square shape (e.g., ▪) 422, 424, 426, 428, 440, 442, 446, 448 for the x-axis. This output measurement information is used as feedback to mitigate the effects of structural uncertainty/failures. The last column shows the simulation results for 1000 different simulations to neutralize the impact of structural uncertainty, environment disturbance, and uncertainty in the initial condition by bounding the location of the node of interest 452, 454, 446, i.e., the top right node as shown. In this example, four sensors are used in each of the truss designs 402, 404, 406 node of interest 452, 454, 446.

As an example, suppose a truss structure is to be deployed on a spacecraft to hold an antenna at a particular orientation in space at node of interest 452, 454, 446. The truss structure does not need to be assembled beforehand. Rather different types of faults can be simulated. For example, in this example space debris or meteorite hits the truss structure, but the antenna orientation is required to remain constant. Then it is possible to plan by location of sensors and parameters for the control algorithm such that even with the planned damage to the truss structure by a meteorite, the antenna will keep its required orientation based on the planned placement of actuators and sensors.

The right column 470, 480, 490 illustrates a point cloud of the initial node positions of the truss structure node of interest 452, 454, 446 before the controller is switched “on.” Next, the controller is switched “on” with the actuators as shown in bold lines of first column 402, 404, 406, with sensing capability at these four nodes in the y-axis, i.e., the square shape (e.g., ▪) 422, 424, 426, 428, 440, 442, 446, 448. Notice that the results reduce the radius, i.e., the uncertainty of the position of the node of interest 452, 454, 446 as shown 471, 473, 475, 477. This example illustrates the reduction in the radius of uncertainty, i.e., the covariance of the displacement of the position of the node of interest. A similar uncertainty reduction is shown in graphs 480, 490 for the other structures 404 and 406.

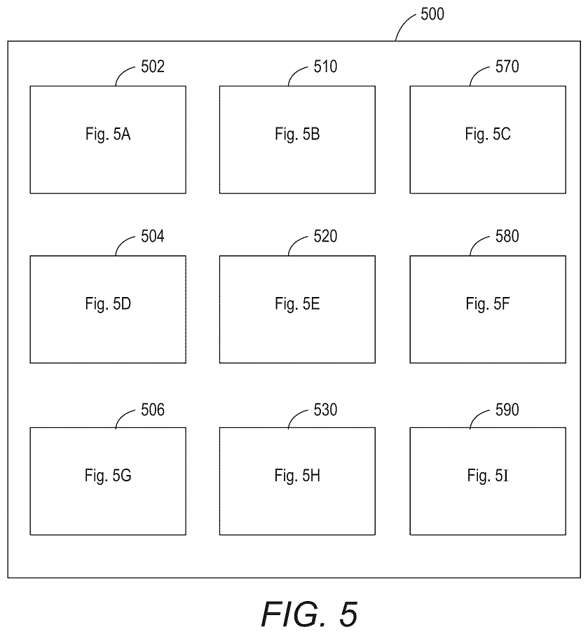

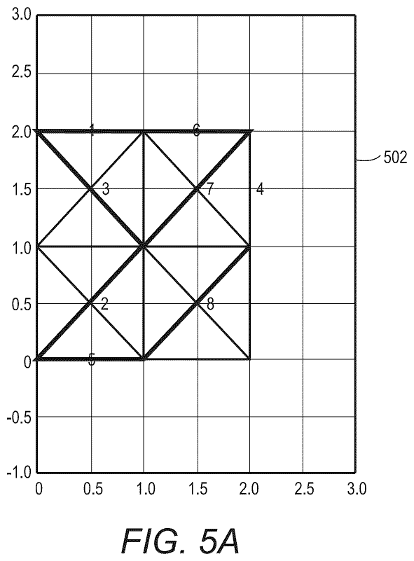

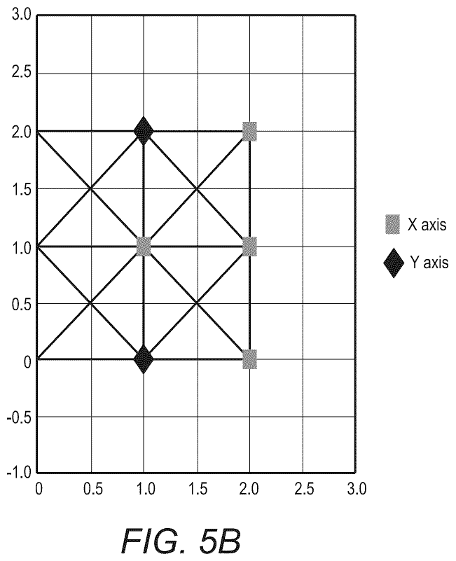

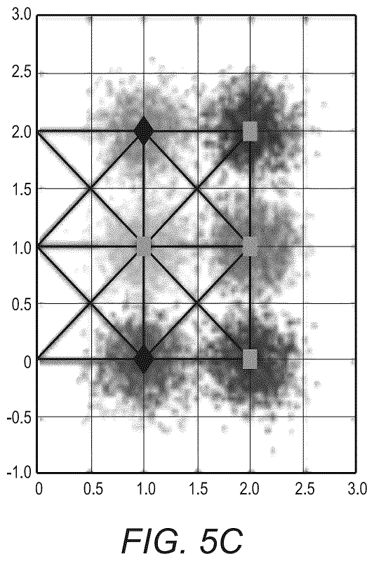

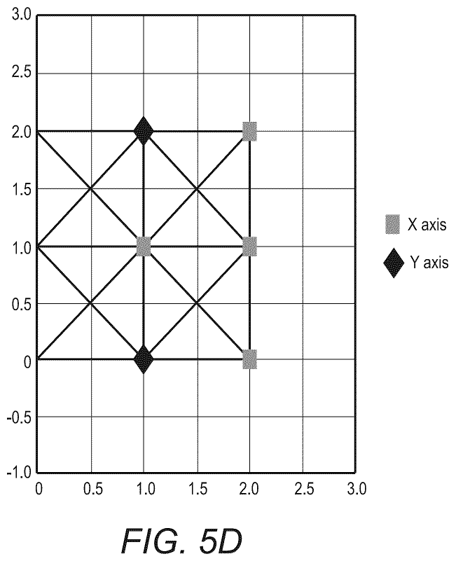

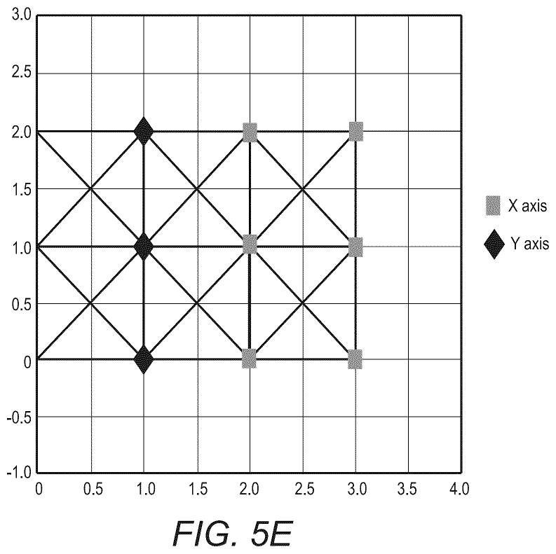

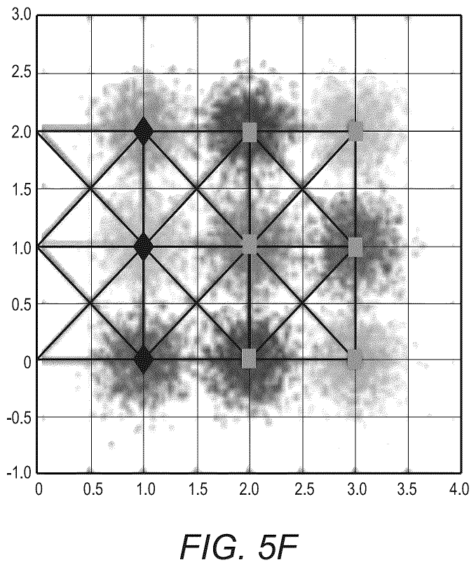

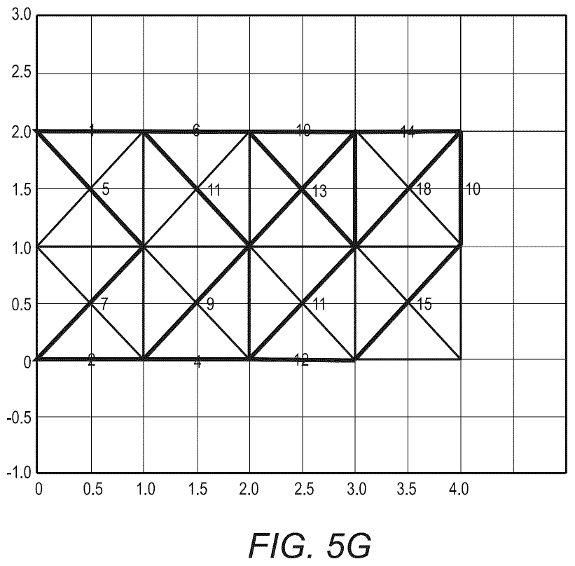

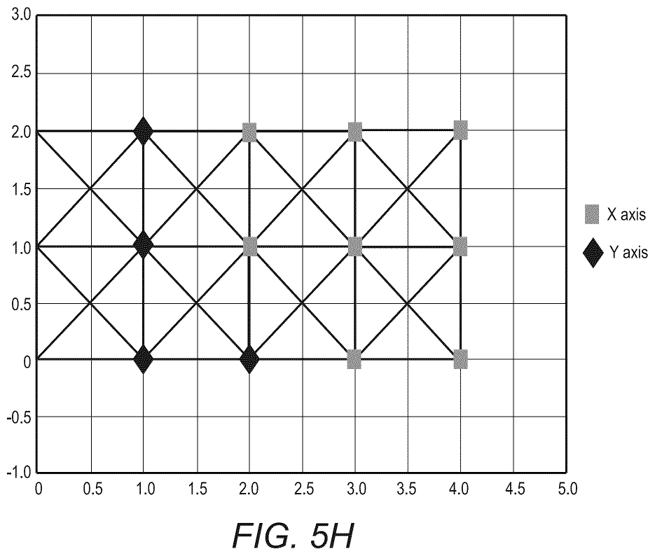

Turning to FIG. 5 and FIG. 5A through FIG. 51 shown is a series of graphs 500 illustrating another SMP-based actuator placement, sensor placement for coordinate measurement of nodes, and simulation results like FIG. 4 but with a higher complexity truss structure. Similar results to FIG. 4 are shown in FIG. 5 for the higher complexity truss structure. Again, the last column shows the simulation results for 1000 different simulations to neutralize the effect of structural uncertainty, environment disturbance, and uncertainty in the initial condition by bounding the location of the node of interest 510, 520, and 530 (the top right node).

### Flow Diagram for Designing Resilient Structures

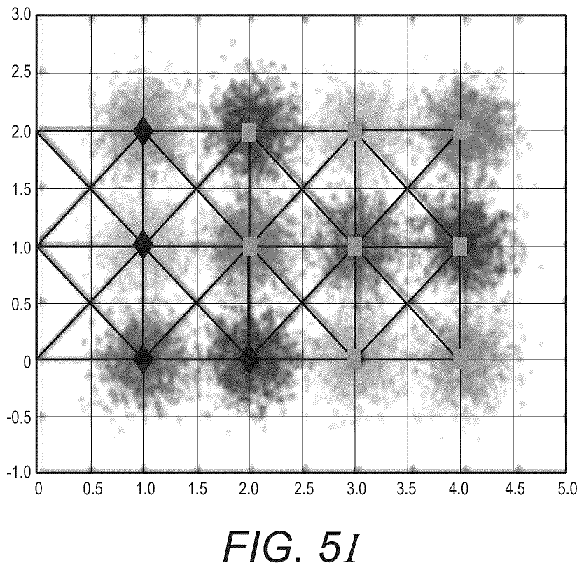

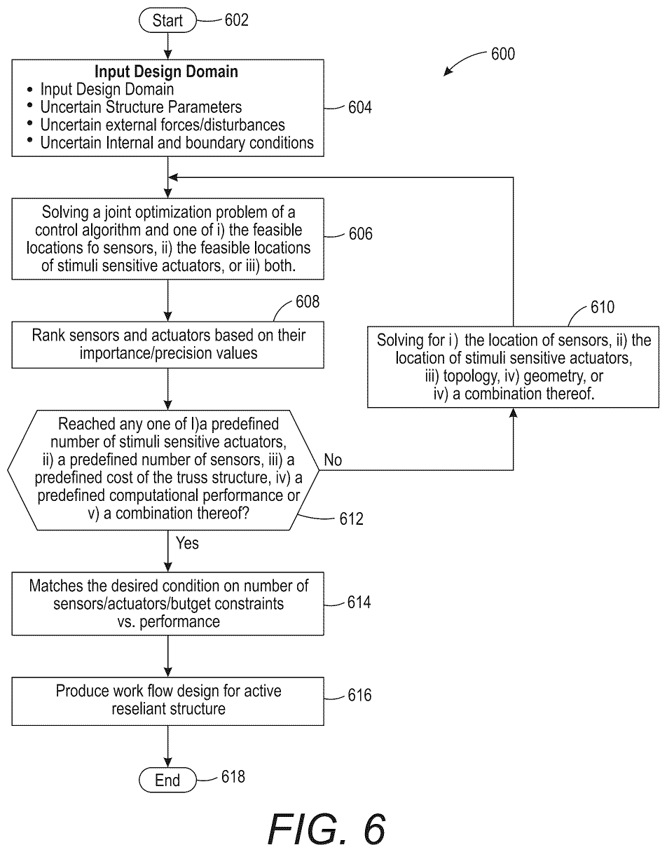

FIG. 6 is a flow diagram 600 for designing resilient structures. The process begins at step 602 and immediately flows to step 604. In step 604, an initial design domain is received for a truss structure formed from a plurality of members connected by nodes. The initial design domain includes i) the feasible location of sensors and/or ii) the feasible location of stimuli sensitive actuators. In one example, the stimuli sensitive actuators may include i) shape-memory polymers (SMP) actuators and/or ii) shape-memory alloy (SMA).

The input design domain may optionally include one or more of a) uncertain truss structure parameters, b) uncertain external forces/disturbances on the truss structure, c) uncertain initial and boundary conditions, d) distributed sensors and actuators and/or e) the number of stimuli sensitive actuators. In another example, the design criteria includes a force output of one or more stimuli sensitive actuators, and wherein producing the design workflow to generate one or more designs of the part includes using the force output to produce the design workflow to provide self-reconfiguring of the active resilient structure. The process continues to step 604.

Step 604 begins a loop 604, 608, and 610, as shown. A joint optimization problem is solved 604, and the results ranked 608. More specifically, the process continues by solving a joint optimization problem of a control algorithm and one of i) the feasible locations of sensors, ii) the feasible locations of stimuli sensitive actuators, or iii) both, by repeatedly solving for i) the location of sensors, ii) the location of stimuli sensitive actuators, iii) topology iv) geometry, or v) a combination thereof. The process continues to step 612.

In step 612, the loop iterates by solving the joint optimization problem continues until one of the following is reached: i) a predefined number of stimuli sensitive actuators, ii) a predefined number of sensors, iii) a predefined cost of the truss structure, iv) a predefined computational performance or v) a combination thereof. The process continues to step 614.

Step 614, the desired condition on the number of sensors/actuators/budget constraints versus performance is matched. The process continues to step 616.

In step 616, at least one workflow design for the active resilient structure is produced. The workflow may include the use of additive manufacturing. The process continues and terminates in step 618.

### Computer Hardware

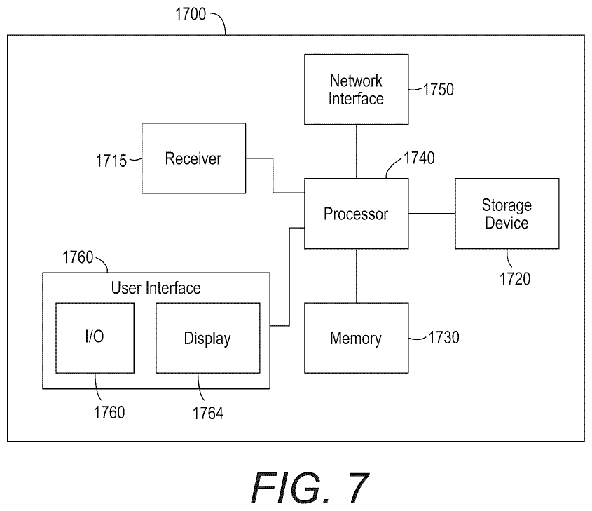

The above-described methods can be implemented on a computer using well-known computer processors, memory units, storage devices, computer software, and other components. A high-level block diagram of such a computer is illustrated in FIG. 7. Computer 700 contains a processor 710, which controls the overall operation of the computer 700 by executing computer program instructions that define such operation. The computer program instructions may be stored in a storage device 720 (e.g., USB disk) and loaded into memory 730 when execution of the computer program instructions is desired. Thus, the steps of the methods described herein may be defined by the computer program instructions stored in memory 730 and controlled by the processor 710 executing the computer program instructions. The computer 700 may include one or more network interfaces 750 for communicating with other devices via a network. The computer 700 also includes a user interface 760 that enables user interaction with the computer 700. The user interface 760 may include I/O devices 762 (e.g., keyboard, mouse, speakers, buttons, etc.) to allow the user to interact with the computer. Such input/output devices 762 may be used in conjunction with a set of computer programs as an annotation tool to annotate images in accordance with the embodiments described herein. The user interface also includes a display 764 for displaying images and spatial realism maps to the user. According to various embodiments, FIG. 7 is a high-level representation of possible components of a computer for illustrative purposes, and the computer may contain other components.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a computer-readable medium and transferred to the processor for execution as is known in the art. The structures and procedures shown above are only a representative example of embodiments that can be used to facilitate embodiments described above.

### Non-Limiting Examples

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

It should be noted that some features of the present invention may be used in one embodiment thereof without the use of other features of the present invention. As such, the foregoing description should be considered as merely illustrative of the principles, teachings, examples, and exemplary embodiments of the present invention, and not a limitation thereof.

Also, these embodiments are only examples of the many advantageous uses of the innovative teachings herein. In general, statements made in the specification of the present application do not necessarily limit any of the various claimed inventions. Moreover, some statements may apply to some inventive features but not to others.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated.

The terminology used herein was chosen to best explain the principles of the embodiments, the practical application or technical improvement over technologies found in the marketplace, or to enable others of ordinary skill in the art to understand the embodiments disclosed herein.

### INCORPORATED REFERENCES

The following publications and other references listed in the Information Disclosure are
hereby incorporated by reference in their entirety:
[1] Raman Goyal, Manoranjan Majji, and Robert E Skelton. Integrating structure, information architecture and control design: Application to tensegrity systems. Mechanical Systems and Signal Processing, 161:107913, 2021.
[2] C. Scherer, P. Gahinet, and M. Chilali. Multiobjective output-feedback control via lmi optimization. IEEE Transactions on Automatic Control, 42(7):896-911, 1997.

What is claimed is:

1. A computer-implemented method for placing sensors and generating control parameters in an active resilient structure design, comprising:
receiving an initial design domain for a truss structure formed from a plurality of members connected by nodes, the initial design domain including one of i) feasible locations of sensors, ii) feasible locations of stimuli sensitive actuators, or iii) both;
iteratively solving a joint optimization problem of a control algorithm and one of i) the feasible locations of sensors, ii) the feasible locations of stimuli sensitive actuators, or iii) both, by repeatedly solving for i) the feasible location of sensors, ii) topology, iii) geometry, or iv) a combination thereof, until reaching one of i) a predefined number of stimuli sensitive actuators, ii) a predefined number of sensors, iii) a predefined cost of the truss structure, iv) a predefined computational performance or v) a combination thereof; and
producing a design workflow to generate one or more designs of a part to comply with a solution to the joint optimization problem that produces an active resilient structure with the feasible location of sensors and stimuli sensitive actuators and parameters for the control algorithm.

2. The method of claim 1, wherein the receiving the initial design domain for the truss structure includes an upper limit on number of stimuli sensitive actuators.

3. The method of claim 1, wherein the receiving the initial design domain for the truss structure includes an upper limit on number of sensors.

4. The method of claim 1, wherein the receiving the initial design domain for the truss structure includes i) all feasible locations of sensors, ii) all feasible locations of stimuli sensitive actuators, or iii) both.

5. The method of claim 1, wherein the predefined cost of the structure includes one of i) a total mass of the structure ii) a total volume of the structure iii) a total cost of sensors iv) a total cost of stimuli sensitive actuators, v) a total monetary cost of the structure, or vi) a combination thereof.

6. The method of claim 1, wherein the stimuli sensitive actuators are one of i) shape-memory polymers (SMP) actuators, ii) shape-memory alloy (SMA), or both.

7. The method of claim 1, wherein the iteratively solving the joint optimization problem results in simultaneous solutions for the control algorithm and the feasible locations of sensors to gather maximum information of the active resilient structure and the control algorithm to neutralize a change due to one of i) uncertainty in properties of the active resilient structure, ii) faults in the active resilient structure, or iii) both.

8. The method of claim 1, wherein iteratively solving the joint optimization problem results in simultaneous solutions for the control algorithm and the feasible locations of stimuli sensitive actuators to actively control the active resilient structure and the control algorithm to neutralize a change due to one of i) uncertainty in properties of the active resilient structure, ii) faults in the active resilient structure, or iii) both.

9. The method of claim 1, wherein iteratively solving the joint optimization problem results in simultaneous solutions for the control algorithm and the feasible locations of sensors to gather maximum information of the active resilient structure and the control algorithm to neutralize a change due to one of i) an uncertainty in environmental conditions of the active resilient structure, ii) an external disturbances to the active resilient structure, or iii) both.

10. The method of claim 1, wherein iteratively solving the joint optimization problem results in simultaneous solutions for the control algorithm and the feasible locations of stimuli sensitive actuators to actively control the active resilient structure and the control algorithm to neutralize a change due to one of i) an uncertainty in environmental conditions of the active resilient structure, ii) an external disturbances to the active resilient structure, or iii) both.

11. The method of claim 1, wherein the receiving the initial design domain for the active resilient structure, includes receiving the initial design domain with one of i) loading conditions, ii) boundary conditions, iii) initial conditions, or iv) a combination thereof.

12. The method of claim 1, wherein the receiving the initial design domain for the active resilient structure, includes receiving the initial design domain with one of i) a node displacement performance bound, ii) a node position performance bound, iii) a node velocity performance bound, or iv) a combination thereof.

13. The method of claim 1, wherein the receiving the initial design domain for the active resilient structure, includes receiving one of i) a minimum bound for covariance of a node, ii) a maximum bound for the covariance of the node, or ii) both, in order to transform one or more characteristics of the active resilient structure towards a passive resilient structure.

14. The method of claim 1, wherein the receiving the initial design domain for the active resilient structure, includes receiving the initial design domain with a force output of one or more stimuli sensitive actuators, and wherein the producing the design workflow to generate one or more designs of the part includes using the force output to produce the design workflow to provide self-reconfiguring of the active resilient structure.

15. The method of claim 1, wherein the producing the design workflow to generate one or more designs of the part includes producing the design workflow to use additive manufacturing to form one or more of the stimuli sensitive actuators.

16. A computer-implemented method for placing stimuli sensitive actuators generating control parameters in an active resilient structure design, comprising:
receiving an initial design domain for a truss structure formed from a plurality of members connected by nodes, the initial design domain including one of i) feasible locations of sensors, ii) feasible locations of stimuli sensitive actuators, or iii) both;
iteratively solving a joint optimization problem of a control algorithm and one of i) the feasible locations of sensors, ii) the feasible locations of stimuli sensitive actuators, or iii) both, by repeatedly solving for i) the location of stimuli sensitive actuators, ii) topology, iii) geometry, or iv) a combination thereof, until reaching one of i) a predefined number of stimuli sensitive actuators, ii) a predefined number of sensors, iii) a predefined cost of the truss structure, iv) a predefined computational performance or v) a combination thereof, and
producing a design workflow to generate one or more designs of a part to comply with a solution to the joint optimization problem that produces an active resilient structure with the location of sensors and stimuli sensitive actuators and parameters for the control algorithm.

17. The method of claim 16, wherein the receiving the initial design domain for the truss structure includes an upper limit on number of stimuli sensitive actuators.

18. The method of claim 16, wherein the receiving the initial design domain for the truss structure includes an upper limit on number of sensors.

19. The method of claim 16, wherein the receiving the initial design domain for the truss structure includes i) all feasible locations of sensors, ii) all feasible locations of stimuli sensitive actuators, or iii) both.

20. A computer-implemented method for placing sensors and stimuli sensitive actuators generating control parameters in an active resilient structure design, comprising:
receiving an initial design domain for a truss structure formed from a plurality of members connected by nodes, the initial design domain including one of i) feasible locations of sensors, ii) feasible locations of stimuli sensitive actuators, or iii) both;
iteratively solving a joint optimization problem of a control algorithm and one of i) the feasible locations of sensors, ii) the feasible locations of stimuli sensitive actuators, or iii) both, by repeatedly solving for i) the location of sensors, ii) the location of stimuli sensitive actuators, iii) topology iv) geometry, or v) a combination thereof, until reaching one of i) a predefined number of stimuli sensitive actuators, ii) a predefined number of sensors, iii) a predefined cost of the truss structure, iv) a predefined computational performance or v) a combination thereof; and
producing a design workflow to generate one or more designs of a part to comply with a solution to the joint optimization problem that produces an active resilient structure with the location of sensors and stimuli sensitive actuators and parameters for the control algorithm.
